(19) United States
(12) Patent Application Publication
(10) Pub. No.: US 2007/0083771 A1
(43) Pub. Date: Apr. 12, 2007

(54) Portable storage device with data security functions and method of protecting data thereof

(76) Inventor: Ping-Hung Chen, Rucho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/246,081

(22) Filed: Oct. 11, 2005

(51) Int. Cl. G06F 12/14

(52) U.S. Cl. 713/193

(57) ABSTRACT

A portable storage device with data security functions includes a data storage unit, a data protection unit and a data authorization unit. The data protection unit is electrically connected between the data storage unit and a data-generating unit, wherein the data protection unit has a corresponding data authorization formula, and the data authorization unit has a data authorization code corresponding to the corresponding data authorization formula. Whereby, the data authorization code and the corresponding data authorization formula correspond continuously to each other by the data authorization unit continuously electrically connecting to the data protection unit for judging what kind of data package can be transmitted to the data-generating unit or the data storage unit through the data protection unit.

### BACKGROUND OF THE INVENTION

1. Field of The Invention

The present invention relates to a portable storage device with data security functions and method of protecting data thereof, and particularly relates to a corresponding data authorization formula (firmware with an encryption/decryption algorithmic formula) installed into a data protection unit, and a data authorization code (an eigenvalue for substituting into the encryption/decryption algorithmic formula) installed into a data authorization unit. Hence, related secret data protected because the data authorization code and the corresponding data authorization formula must correspond to each other. Moreover, this method has the advantage that a hardware encryption/decryption device is not required.

2. Description of the Related Art

The present generation has seen both an explosion of information and its digitization, the information communication is becoming extremely important. E-mail, which uses a computer, a cell phone or a Personal Digital Assistant (PDA), passes between sender and receiver through the Internet.

Flash memory is widely used as a storage medium in mobile disks or memory cards that are adapted for portable storage devices such as digital cameras, cell phones or MP3 players, etc. Mobile disks or memory cards with large capacity and high transmission speed have maintained their initial high price in the marketplace because technical problems that have not been overcome, and the cost of flash memory still remains high.

Moreover, large-sized digital files such as pictures with high resolution and definition, multimedia with excellent sound quality and much sampling frequency, or briefings that have a number of pictures or a large amount of text, etc. occupy a vast amount of storage space in a mobile disk or a memory card.

In order to solve these issues, a portable hard disk with a USB (Universal Serial Bus) interface is created through the combination of a computer hard disk and a transmission interface. A portable hard disk with a USB interface can be adapted to a notebook or a desktop computer, and has an extremely large capacity, a high transmission speed and small size.

In general, both the capacity and the transmission speed of a hard disk are excellent. Hence, when a portable hard disk is combined with the hard disk of a computer the transmission interface can increase the capacity and the transmission speed of a portable storage device of the prior art. For example, the capacity of a mobile disk or a memory card is always less than 10 GB, and the capacity of a portable hard disk is always more than 10 GB.

However, sometimes data is easily stolen or falsified during transmission. Any secret data stored in a portable hard disk cannot be protected. In order to solve this problem, many kinds of portable hard disks with data security functions have been provided for protecting the secret data during transmission. In general, one way to protect secret data is through software encryption/decryption. The alternative way is through hardware encryption/decryption.

However, the encryption/decryption methods still have some defects, as are detailed below:

1. With regard to the software encryption/decryption method, related security software or programs must be attached to a pre-encryption file or be installed into a host computer. However, a person skilled in the art can easily overcome the security software or program. Hence, the security properties of the software encryption/decryption method are lower.

2. With regard to the hardware encryption/decryption method, extra hardware encryption/decryption devices must be installed in the portable hard disk. Although the security properties of the hardware encryption/decryption method are higher, the manufacturing cost of the encryption/decryption device is also higher. Moreover, the same hardware encryption/decryption device cannot be used for different types of portable hard disks. In other words, users must buy different types of hardware encryption/decryption devices for different types of portable hard disks. Hence, the consumer's incentive to purchase the device is reduced.

### SUMMARY OF THE INVENTION

The present invention provides a corresponding data authorization formula (firmware with an encryption/decryption algorithmic formula) that is installed into a data protection unit, and a data authorization code (an eigenvalue for substituting into the encryption/decryption algorithmic formula) installed into a data authorization unit. Hence, related secret data protected because the data authorization code and the corresponding data authorization formula must correspond to each other. Moreover, this method has the advantage that a hardware encryption/decryption device is not required.

Moreover, the data protection unit has a socket module for receiving the data authorization unit with the data authorization code (chip key). Hence, the present invention can judge what kind of data package can be transmitted to the data-generating unit or the data storage unit through the data protection unit by judging whether the data authorization code and the corresponding data authorization formula correspond continuously to each other.

Furthermore, the data protection unit further comprises a start authorization unit, and the data authorization code is processed via the start authorization unit to generate a start authorization code corresponding to the data authorization code, wherein when the start authorization code is transmitted to the data storage unit, the data storage unit obtains a start authorization from the data protection unit for preparing related data packages that require authorization for transmission between the data-generating unit and the data storage unit.

A first aspect of the invention is a portable storage device with data security functions. The portable storage device comprises a data storage unit, a data protection unit and a data authorization unit. The data protection unit is electrically connected between the data storage unit and a data-generating unit, wherein the data protection unit has a corresponding data authorization formula, and the data authorization unit has a data authorization code corresponding to the corresponding data authorization formula. Whereby, the data authorization code and the corresponding data authorization formula correspond continuously to each other by the data authorization unit continuously electrically connecting to the data protection unit for judging what kind of data package can be transmitted to the data-generating unit or the data storage unit through the data protection unit.

Moreover, the data protection unit further comprises a start authorization unit, and the data authorization code is processed via the start authorization unit to generate a start authorization code corresponding to the data authorization code, wherein when the start authorization code is transmitted to the data storage unit, the data storage unit obtains a start authorization from the data protection unit for related data packages that require authorization so that preparation can be made to transmit between the data-generating unit and the data storage unit.

A second aspect of the invention is a method of protecting data adapted to a portable storage device. The method comprises the following steps: providing a data protection unit having a corresponding data authorization formula, and a data authorization unit having a data authorization code; judging whether the data authorization code and the corresponding data authorization formula correspond continuously to each other by the data authorization unit continuously electrically connecting to the data protection unit; and judging what kind of data package can be transmitted to the data-generating unit or the data storage unit through the data protection unit by judging whether the data authorization code and the corresponding data authorization formula correspond continuously to each other.

Moreover, in the step of judging whether the data authorization code and the corresponding data authorization formula correspond continuously to each other, if they do correspond, authorizing data packages that require authorization to be transmitted to the data-generating unit or the data storage unit through the data protection unit, and if they do not correspond, only data packages that do not require authorization are allowed to be transmitted to the data-generating unit or the data storage unit through the data protection unit.

Furthermore, the method further comprises judging whether the data authorization unit electrically connects with the data protection unit during transmission of the data packages. If the data authorization unit electrically connects with the data protection unit during transmission, the data packages are transmitted continuously. If the data authorization unit does not electrically connect with the data protection unit during the transmission of the data packages, only allowing data packages that do not require authorization to be transmitted continuously. If the data authorization unit does not electrically connect with the data protection unit during the transmission of the data packages, stopping the transmission of all data packages.

Furthermore, after the step of providing the data protection unit and the data authorization unit, the method further comprises the following steps: transmitting the data authorization code to a start authorization module of the data protection unit; processing the data authorization code via the start authorization unit to generate a start authorization code; storing the start authorization code in the data storage unit; and finally judging whether the start authorization code stored in the data storage unit and the data authorization code correspond continuously to each other for determining whether the data storage unit obtains a start authorization from the data protection unit.

In the step of judging whether the start authorization code stored in the data storage unit and the data authorization code correspond continuously to each other, if they do correspond, the data storage unit obtains a start authorization from the data protection unit for preparing the data packages that require authorization and do not require authorization to transmit between the data-generating unit and the data storage unit; if they do not correspond, the data storage unit cannot obtain a start authorization from the data protection unit for preparing any data packages that do not require authorization to transmit between the data-generating unit and the data storage unit.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objects and advantages of the present invention will be more readily understood from the following detailed description when read in conjunction with the appended drawings, in which:

FIG. 1 is a function block of a portable storage device with data security functions in accordance with the present invention;

FIG. 2 is a flow chart of a method of protecting data adapted to a portable storage device in accordance with the first embodiment of the present invention;

FIG. 3 is a flow chart of a method of protecting data adapted to a portable storage device in accordance with the second embodiment of the present invention; and

FIG. 4 is a flow chart of a method of protecting data adapted to a portable storage device in accordance with the third embodiment of the present invention.

### DETAILED DESCRIPTION OF PREFERRED EMBODIMENTS

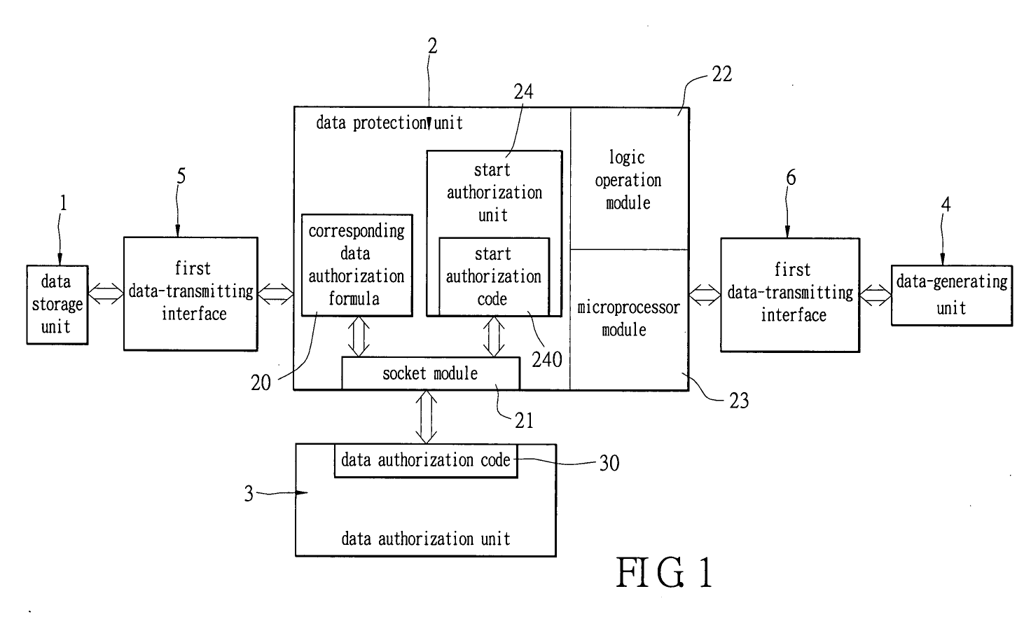

FIG. 1 shows a function block of a portable storage device with data security functions in accordance with the present invention. The present invention provides a portable storage device with data security functions, including a data storage unit 1, a data protection unit 2 and a data authorization unit 3.

The data storage unit 1 can be a hard disk, a floppy disk, a CD-RW, an MO (Magnetic Optical Device), a DVR (Digital Video Recorder), a FM (Flash Memory) card or any kind of data storage device.

Moreover, the data protection unit 2 is electrically connected between the data storage unit 1 and a data-generating unit 4, and the data protection unit 2 has a corresponding data authorization formula 20 that can be an encryption/decryption algorithmic formula. The data-generating unit 4 can be a computer, a notebook, a microprocessor, a PDA, an interface card, a router or any kind of data-generating device.

Furthermore, the data authorization unit 3 has a data authorization code 30 corresponding to the corresponding data authorization formula 20 that can be an eigenvalue for substituting into the encryption/decryption algorithmic formula. In addition, the data protection unit 2 has a socket module 21, and the data authorization unit 3 can be a chip key that is inserted into the socket module 21 for the data authorization unit electrically connecting with the data protection unit. The socket module 21 can be a chip card type socket, a SIM (Subscriber Identity Module) card type socket or any kind of socket for receiving the data authorization unit 3.

Additionally, the data protection unit 2 further includes a logic operation module 22 and a microprocessor module 23. The logic operation module 22 is used to calculate and judge whether the data authorization code 30 and the corresponding data authorization formula 20 correspond continuously to each other, or whether the data authorization code 30 is only one eigenvalue of the corresponding data authorization formula 20. The microprocessor module 23 is used to control the logic operation module 22. Moreover, the logic operation module 22 can receive commands from the data-generating unit 4 for executing related operations such as command controls or data transmissions.

Hence, the data authorization code 30 and the corresponding data authorization formula 20 correspond continuously to each other by the data authorization unit 3 continuously electrically connecting to the data protection unit 2 for judging or determining what kind of data package (including data packages that require authorization and do not require authorization) can be encrypted/decrypted and transmitted to the data-generating unit 4 or the data storage unit 1 through the data protection unit.

In other words, when the data authorization unit 3 is continuously electrically connected to the data protection unit 2, the data authorization code 30 and the corresponding data authorization formula 20 correspond continuously to each other (or judge whether the data authorization code 30 is only one eigenvalue of the corresponding data authorization formula 20). If the above-mentioned correspondence is correct (or the data authorization code 30 is only one eigenvalue of the corresponding data authorization formula 20), a secrecy switch of the portable storage device is opened. Hence, the data packages that require authorization (the data packages in a protected zone) or do not require authorization (the data packages in an unprotected zone) are transmitted to the data-generating unit 4 or the data storage unit 1 through the encryption/decryption of the corresponding data authorization formula 20 of the data protection unit 2.

Moreover, if the data authorization unit 3 does not electrically connect with the data protection unit 2 during the transmission of the data packages, it only allows data packages that do not require authorization (the data packages in non-protected zone) to be transmitted continuously to the data-generating unit 4 or data storage unit 1 through the data protection unit 2.

Furthermore, the portable storage device of the present invention further includes a first data-transmitting interface 5 arranged between the data storage unit 1 and the data protection unit 2, and a second data-transmitting interface 6 arranged between the data protection unit 2 and the data-generating unit 4. The first data-transmitting interface 5 can be an IDE (Integrated Device Electronics) interface, a CF (Compact Flash) card interface or an SATA (Serial Advanced Technology Attachment) interface.

The second data-transmitting interface 5 can be an SATA (Serial Advanced Technology Attachment) interface, a USB interface, an IEEE (Institute of Electrical and Electronic Engineers) interface or a USB OTG (On-The-Go) interface. In addition, the data storage unit 1 can be a data storage device with a USB interface by using the USB OTG (On-The-Go) interface, and the data storage device can be a mobile disk with a USB interface, a card reader with a USB interface, a hard disk with a USB interface, an optical device with a USB interface and a digital camera with a USB interface.

Moreover, the data protection unit 2 further includes a start authorization unit 24, and the data authorization code 30 is processed via the start authorization unit 24 to generate a start authorization code 240 corresponding to the data authorization code 30. When the start authorization code 24 is transmitted to the data storage unit 1, the data storage unit 1 obtains a start authorization from the data protection unit for preparing related data packages that require authorization to transmit between the data-generating unit and the data storage unit.

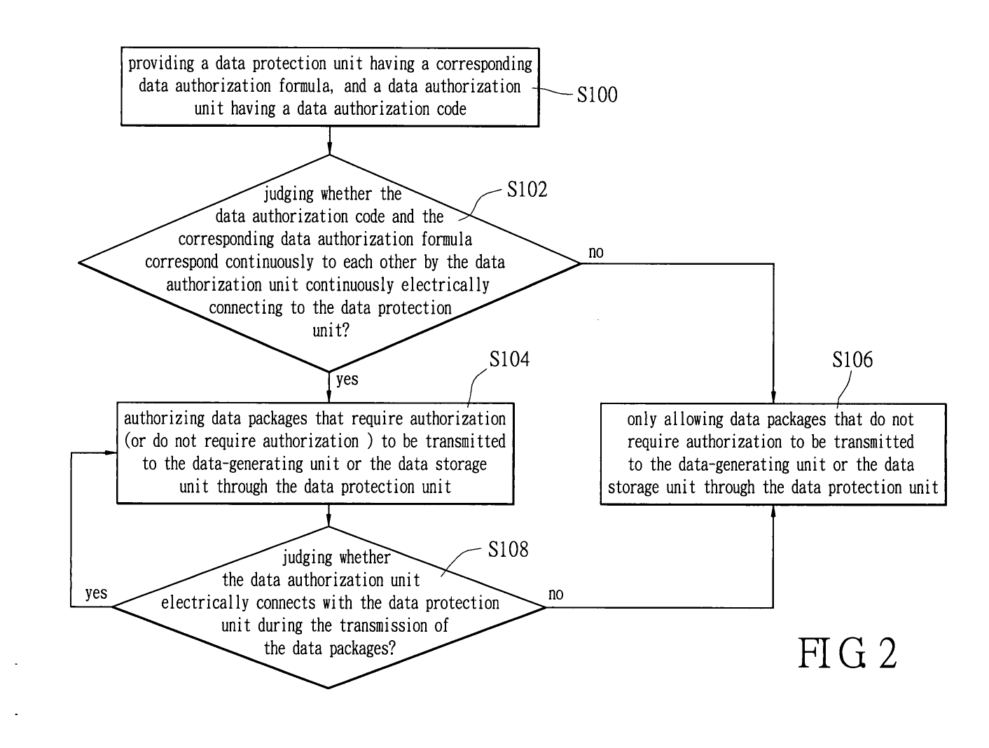

FIG. 2 shows a flow chart of a method of protecting data adapted to a portable storage device in accordance with the first embodiment of the present invention. The method according to the first embodiment of the present invention includes the following steps: providing a data protection unit 2 having a corresponding data authorization formula 20, and a data authorization unit 3 having a data authorization code 30 (S100), and judging whether the data authorization code 30 and the corresponding data authorization formula 20 correspond continuously to each other by the data authorization unit 3 continuously electrically connecting to the data protection unit 2 (S102). The data authorization unit 3 can be a chip key, the corresponding data authorization formula 20 can be an encryption/decryption algorithmic formula, and the data authorization code 30 can be an eigenvalue for substituting into the encryption/decryption algorithmic formula. Hence, the step of judging whether the data authorization code 30 and the corresponding data authorization formula 20 correspond continuously to each other involves substituting the data authorization code 30 into the corresponding data authorization formula 20 for judging whether the data authorization code 30 is only one eigenvalue of the corresponding data authorization formula 20.

Afterward, if the data authorization code 30 and the corresponding data authorization formula 20 correspond continuously to each other, authorizing data packages that require authorization (the data packages in the protected zone) or do not require authorization (the data packages in the unprotected zone) to be transmitted to the data-generating unit 4 or the data storage unit 1 through the data protection unit 2 (S104). In addition, the corresponding data authorization formula 20 can correspond to different data authorization codes 30 according to different users for determining a user's access level.

If the data authorization code 30 and the corresponding data authorization formula 20 do not correspond continuously to each other, only data packages that do not require authorization (the data packages in non-protected zone) are allowed to be transmitted to the data-generating unit 4 or the data storage unit 1 through the data protection unit 2 (S106).

Hence, according to the above-mentioned descriptions, the method of the present invention can judge what kind of data package can be transmitted to the data-generating unit 4 or the data storage unit 1 through the data protection unit 2 by judging whether the data authorization code 30 and the corresponding data authorization formula 20 correspond continuously to each other.

Next, the method further includes judging whether the data authorization unit 3 electrically connects with the data protection unit 2 during the transmission of the data packages (S108), if it does correspond, continuously executing the step S104 (the data packages are transmitted continuously); if it does not correspond, continuously executing the step S106 (only allowing data packages that do not require authorization to be transmitted continuously). Moreover, in another design, when the data authorization code 30 and the corresponding data authorization formula 20 do not correspond continuously to each other or the data authorization unit 3 does not electrically connect with the data protection unit 2 during the transmission of the data packages, stopping the transmission of all data packages.

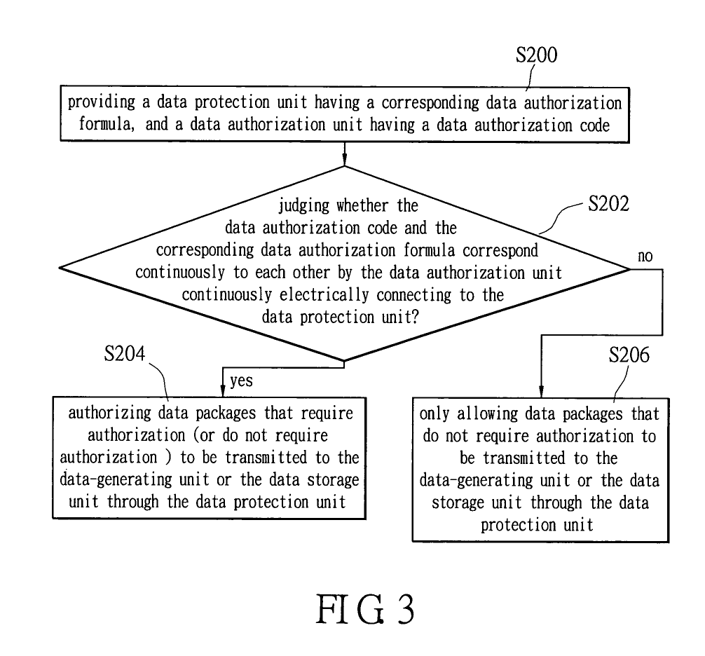

FIG. 3 shows a flow chart of a method of protecting data adapted to a portable storage device in accordance with the second embodiment of the present invention. The steps S200 to S206 in accordance with the second embodiment are the same as the steps S100 to S106 in accordance with the first embodiment. The difference between the second embodiment and the first embodiment is that the data authorization unit 3 must continuously be electrically connected with the data protection unit 2 during the transmission of the data packages, or else problems will occur. Hence, the second embodiment does not need the step S108 of the first embodiment.

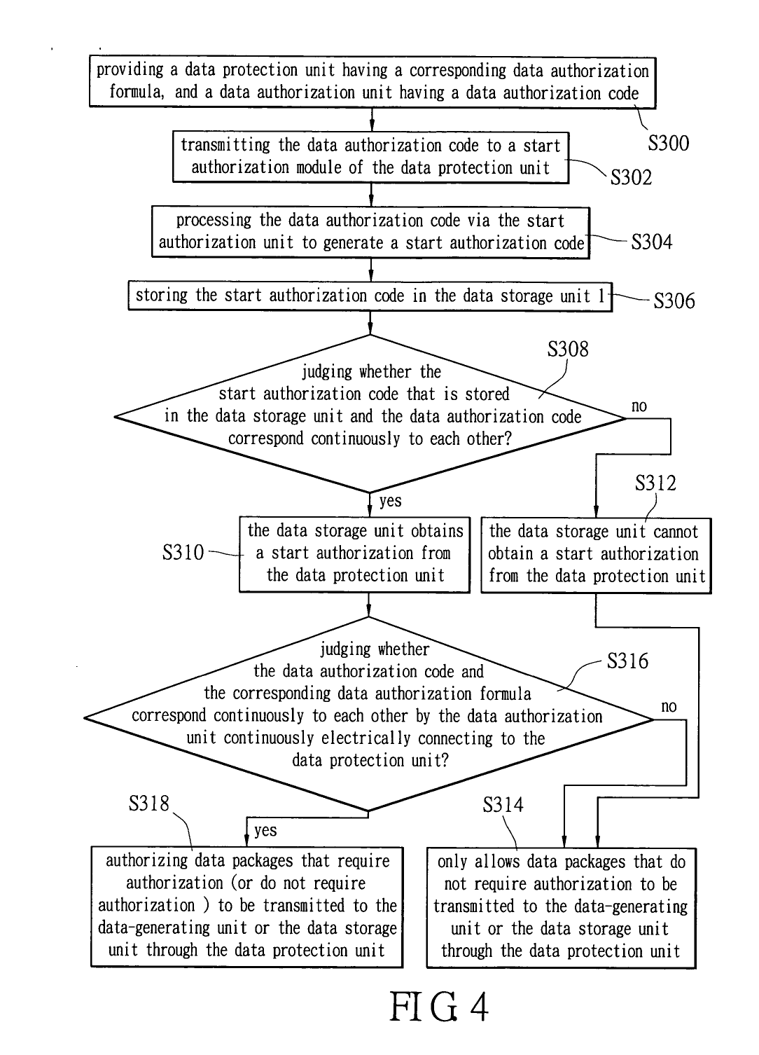

FIG. 4 shows a flow chart of a method of protecting data adapted to a portable storage device in accordance with the third embodiment of the present invention. The step S300 of the third embodiment is the same as the step S200 of the second embodiment. After the step S300, the method of the third embodiment further includes: transmitting the data authorization code 30 to a start authorization module 24 of the data protection unit 2 (S302); processing the data authorization code 30 via the start authorization unit 24 to generate a start authorization code 240 (S304); storing the start authorization code 240 in the data storage unit 1 (S306); and judging whether the start authorization code 240 that is stored in the data storage unit 1 and the data authorization code 30 correspond continuously to each other (S308) for determining whether the data storage unit 1 obtains a start authorization from the data protection unit 30.

Moreover, in the judgment of step S308, if it does correspond, the data storage unit 1 obtains a start authorization from the data protection unit 2 (S310) for preparing data packages that require authorization and do not require authorization to transmit between the data-generating unit and the data storage unit; if it does not correspond, the data storage unit 1 cannot obtain a start authorization from the data protection unit 2 (S312) and only allows data packages that do not require authorization to be transmitted to the data-generating unit 4 or the data storage unit 1 through the data protection unit 2 (S314) such as in the step S206. In addition, the steps S316 and S318 in accordance with the third embodiment are the same as the steps S202 and S204 in accordance with the second embodiment.

To sum up, the portable storage device with data security functions of the present invention has some key points that solve the problems of the prior art, as are detailed below:

1. The corresponding data authorization formula 20 is used as an encryption/decryption algorithmic device that doesn't require software to act as an encryption/decryption algorithmic device such as the prior art that detracts from the system efficiency of a host computer.

2. Because the corresponding data authorization formula 20 is installed in the data protection unit 2, the present invention does not need to use hardware to be an encryption/decryption algorithmic device. Hence, costs are lowered and the protective efficiency is the same as the hardware of the prior art.

3. The data protection unit 2 has a socket module 21 for receiving the data authorization unit 3 with the data authorization code 30 (chip key). Hence, the present invention can judge what kind of data package can be transmitted to the data-generating unit 4 or the data storage unit 1 through the data protection unit 2 by judging whether the data authorization code 30 and the corresponding data authorization formula 20 correspond continuously to each other.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A portable storage device with data security functions, comprising:
a data storage unit;
a data protection unit electrically connected between the data storage unit and a data-generating unit, wherein the data protection unit has a corresponding data authorization formula; and
a data authorization unit having a data authorization code corresponding to the corresponding data authorization formula;
wherein the data authorization code and the corresponding data authorization formula correspond continuously to each other through the data authorization unit continuously electrically connecting to the data protection unit for judging what kind of data package can be transmitted to the data-generating unit or the data storage unit through the data protection unit.

2. The portable storage device as claimed in claim 1, wherein the data authorization unit is a chip key, the corresponding data authorization formula is an encryption/decryption algorithmic formula, and the data authorization code is an eigenvalue for substituting into the encryption/decryption algorithmic formula.

3. The portable storage device as claimed in claim 1, further comprising a first data-transmitting interface arranged between the data storage unit and the data protection unit, and a second data-transmitting interface arranged between the data protection unit and the data-generating unit, wherein the second data-transmitting interface is a SATA (Serial Advanced Technology Attachment) interface, a USB interface, an IEEE interface or a USB OTG (On-The-Go) interface.

4. The portable storage device as claimed in claim 3, wherein the data storage unit is a data storage device with a USB interface by using the USB OTG (On-The-Go) interface, and the data storage device is a mobile disk with a USB interface, a card reader with a USB interface, a hard disk with a USB interface, an optical device with a USB interface or a digital camera with a USB interface.

5. The portable storage device as claimed in claim 1, wherein the data protection unit is a socket module for receiving the data authorization unit.

6. The portable storage device as claimed in claim 1, the data protection unit further comprises a start authorization unit, and the data authorization code is processed via the start authorization unit to generate a start authorization code corresponding to the data authorization code, wherein when the start authorization code is transmitted to the data storage unit, the data storage unit obtains a start authorization from the data protection unit for preparing related data packages that require authorization for transmission between the data-generating unit and the data storage unit.

7. A method of protecting data adapted to a portable storage device, comprising:
providing a data protection unit having a corresponding data authorization formula, and a data authorization unit having a data authorization code;
judging whether the data authorization code and the corresponding data authorization formula correspond continuously to each other through the data authorization unit continuously electrically connecting to the data protection unit; and
judging what kind of data package can be transmitted to the data-generating unit or the data storage unit through the data protection unit by judging whether the data authorization code and the corresponding data authorization formula correspond continuously to each other.

8. The method as claimed in claim 7, wherein the data authorization unit is a chip key, the corresponding data authorization formula is an encryption/decryption algorithmic formula, and the data authorization code is an eigenvalue for substituting into the encryption/decryption algorithmic formula.

9. The method as claimed in claim 7, further comprising a first data-transmitting interface arranged between the data storage unit and the data protection unit, and a second data-transmitting interface arranged between the data protection unit and the data-generating unit, wherein the second data-transmitting interface is an SATA (Serial Advanced Technology Attachment) interface, a USB interface, a IEEE interface or USB OTG (On-The-Go) interface.

10. The method as claimed in claim 9, wherein the data storage unit is a data storage device with a USB interface by using the USB OTG (On-The-Go) interface, and the data storage device is a mobile disk with a USB interface, a card reader with a USB interface, a hard disk with a USB interface, an optical device with a USB interface, or a digital camera with a USB interface.

11. The method as claimed in claim 7, wherein the data protection unit is a socket module for receiving the data authorization unit.

12. The method as claimed in claim 7, wherein in the step of judging whether the data authorization code and the corresponding data authorization formula correspond continuously to each other;
wherein if the data authorization code and the corresponding data authorization formula correspond continuously to each other, authorizing data packages that require authorization to be transmitted to the data-generating unit or the data storage unit through the data protection unit; and
wherein if the data authorization code and the corresponding data authorization formula do not correspond continuously to each other, only data packages that do not require authorization are allowed to be transmitted to the data-generating unit or the data storage unit through the data protection unit.

13. The method as claimed in claim 7, further comprising judging whether the data authorization unit electrically connects with the data protection unit during the transmission of the data packages.

14. The method as claimed in claim 13, wherein if the data authorization unit electrically connects with the data protection unit during the transmission of the data packages, the data packages are transmitted continuously.

15. The method as claimed in claim 13, wherein if the data authorization unit does not electrically connect with the data protection unit during the transmission of the data packages, only allowing data packages that do not require authorization to be transmitted continuously.

16. The method as claimed in claim 13, wherein if the data authorization unit does not electrically connect with the data protection unit during the transmission of the data packages, stopping the transmission of all data packages.

17. The method as claimed in claim 7, wherein the step of judging whether the data authorization code and the corresponding data authorization formula correspond continuously to each other means that substituting the data authorization code into the corresponding data authorization formula for judging whether the data authorization code is only one eigenvalue of the corresponding data authorization formula.

18. The method as claimed in claim 7, wherein after the step of providing the data protection unit and the data authorization unit, further comprises:
transmitting the data authorization code to a start authorization module of the data protection unit;
processing the data authorization code via the start authorization unit to generate a start authorization code;
storing the start authorization code in the data storage unit; and judging whether the start authorization code stored in the data storage unit and the data authorization code correspond continuously to each other for determining whether the data storage unit obtains can obtain a start authorization from the data protection unit.

19. The method as claimed in claim 18, wherein in the step of judging, if the start authorization code and the data authorization code correspond continuously to each other, the data storage unit obtains can obtain a start authorization from the data protection unit for preparing data packages that require authorization and do not require authorization to transmit between the data-generating unit and the data storage unit.

20. The method as claimed in claim 18, wherein in the step of judging, if the start authorization code and the data authorization code do not correspond continuously to each other, the data storage unit cannot obtain a start authorization from the data protection unit for only preparing data packages that do not require authorization to transmit between the data-generating unit and the data storage unit.
